(19) United States
(12) Patent Application Publication
(10) Pub. No.: US 2012/0033143 A1
(43) Pub. Date: Feb. 9, 2012

(54) TELEVISION AND ELECTRONIC APPARATUS

(75) Inventor: Kenji Nonaka, Kumagaya-shi (JP)

(73) Assignee: KABUSHIKI KAISHA TOSHIBA, Tokyo (JP)

(21) Appl. No.: 13/175,334

(22) Filed: Jul. 1, 2011

(30) Foreign Application Priority Data
Aug. 5, 2010 (JP) 2010-176652

(51) Int. Cl. H04N 5/64

(52) U.S. Cl. 348/843; 348/E05.128

(57) ABSTRACT

According to one embodiment, an electronic apparatus includes a glass panel, a first fixing portion including a first portion attached to the glass panel and a second portion configured to face the glass panel, and a display panel configured to be slid up to a position where a portion of the display panel is interposed between the glass panel and the second portion of the first fixing portion and to overlap the glass panel.

### CROSS-REFERENCE TO RELATED APPLICATIONS

This application is based upon and claims the benefit of priority from Japanese Patent Application No. 2010-176652, filed Aug. 5, 2010, the entire contents of which are incorporated herein by reference.

### FIELD

Embodiments described herein relate generally to a television and an electronic apparatus including a display panel.

### BACKGROUND

A television includes a display panel and a front cover attached to the display panel.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an example of a television according to an embodiment;

FIG. 2 is an exemplary exploded perspective view illustrating a display unit shown in FIG. 1;

FIG. 3 is an exemplary perspective view illustrating a first fixing portion shown in FIG. 2;

FIG. 4 is an exemplary perspective view illustrating the first fixing portion shown in FIG. 2, as viewed from a different angle;

FIG. 5 is an exemplary cross-sectional view illustrating the first fixing portion taken along the line A-A of FIG. 4;

FIG. 6 is an exemplary cross-sectional view illustrating the first fixing portion taken along the line A-A of FIG. 4;

FIG. 7 is an exemplary cross-sectional view illustrating a second fixing portion taken along the line B-B of FIG. 2;

FIG. 8 is an exemplary cross-sectional view illustrating the second fixing portion taken along the line B-B of FIG. 2;

FIG. 9 is an exemplary plan view illustrating a glass panel shown in FIG. 2;

FIG. 10 is an exemplary plan view illustrating the state of the first fixing portion shown in FIG. 9 before a display panel is inserted;

FIG. 11 is an exemplary plan view illustrating the state of the first fixing portion shown in FIG. 10 after the display panel is inserted;

FIG. 12 is an exemplary plan view illustrating the attached state of a second member of a third fixing portion shown in FIG. 11; and

FIG. 13 is an exemplary plan view illustrating a fourth fixing portion attached to the third fixing portion shown in FIG. 12.

### DETAILED DESCRIPTION

Various embodiments will be described hereinafter with reference to the accompanying drawings.

In general, according to one embodiment, an electronic apparatus comprises a glass panel, a first fixing portion comprising a first portion attached to the glass panel and a second portion configured to face the glass panel, and a display panel configured to be slid up to a position where a portion of the display panel is interposed between the glass panel and the second portion of the first fixing portion and to overlap the glass panel.

Hereinafter, exemplary embodiments will be described with reference to the accompanying drawings.

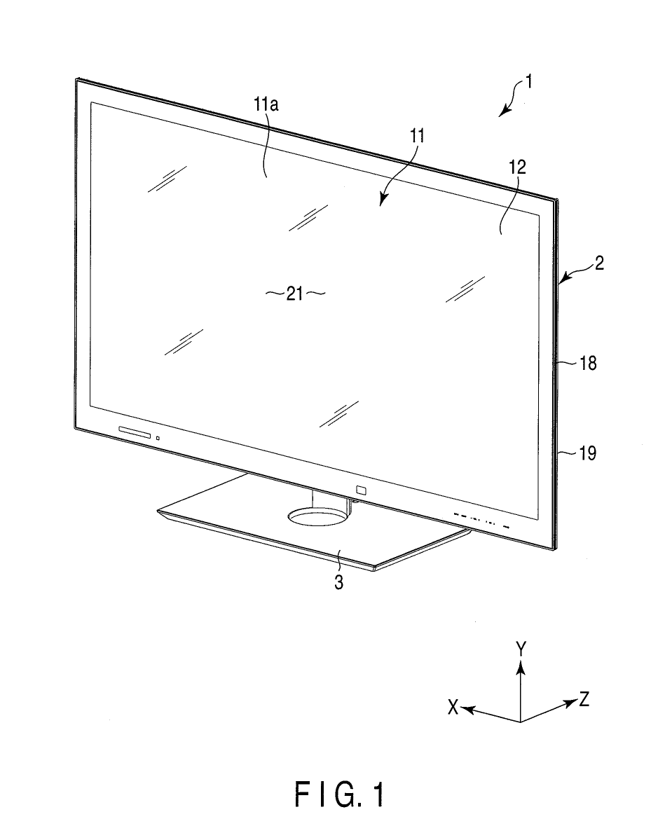

FIGS. 1 to 13 show a television 1 according to an embodiment. The television 1 is an example of an electronic apparatus. The electronic apparatus to which this embodiment can be applied is not limited to the television, but this embodiment can be widely applied to various kinds of electronic apparatuses.

As shown in FIG. 1, the television 1 includes a display unit 2 and a stand 3. The stand 3 is configured to be placed on, for example, a television table. The display unit 2 is flat and is supported by the stand 3 while standing substantially in the vertical direction.

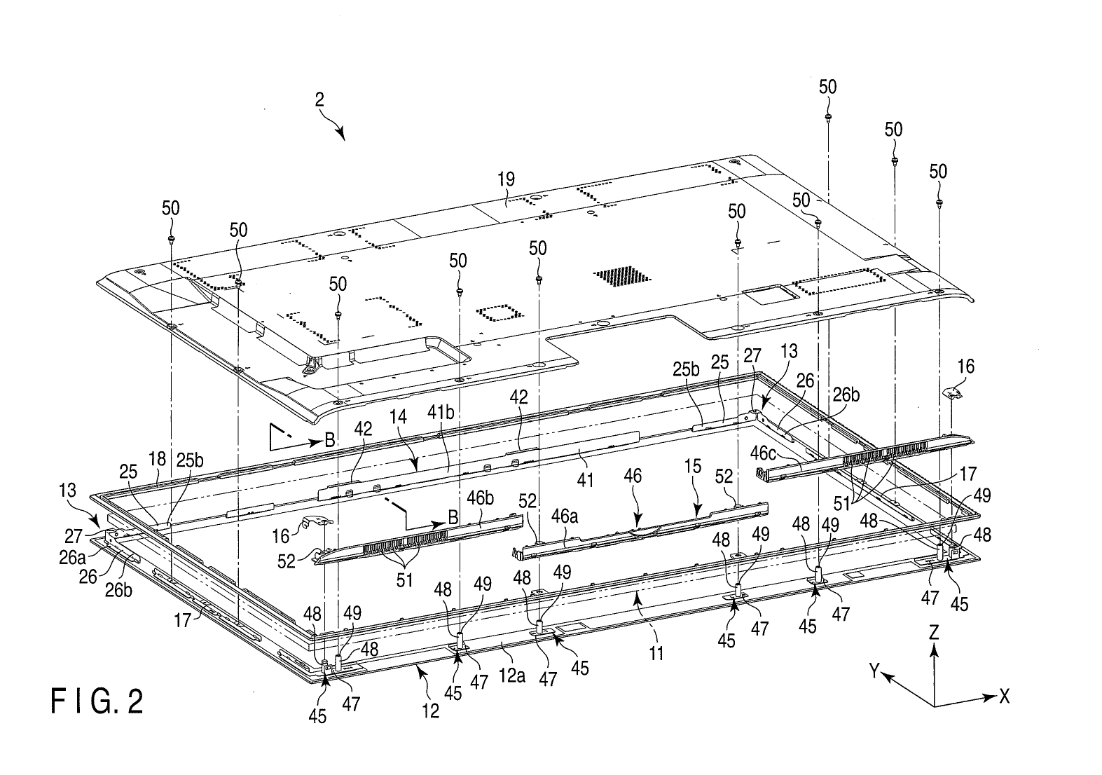

As shown in FIG. 2, the display unit 2 includes a display panel 11, a glass panel 12, first fixing portions 13, a second fixing portion 14, a third fixing portion 15, fourth fixing portions 16, fifth fixing portions 17, a bezel 18, and a back cover 19.

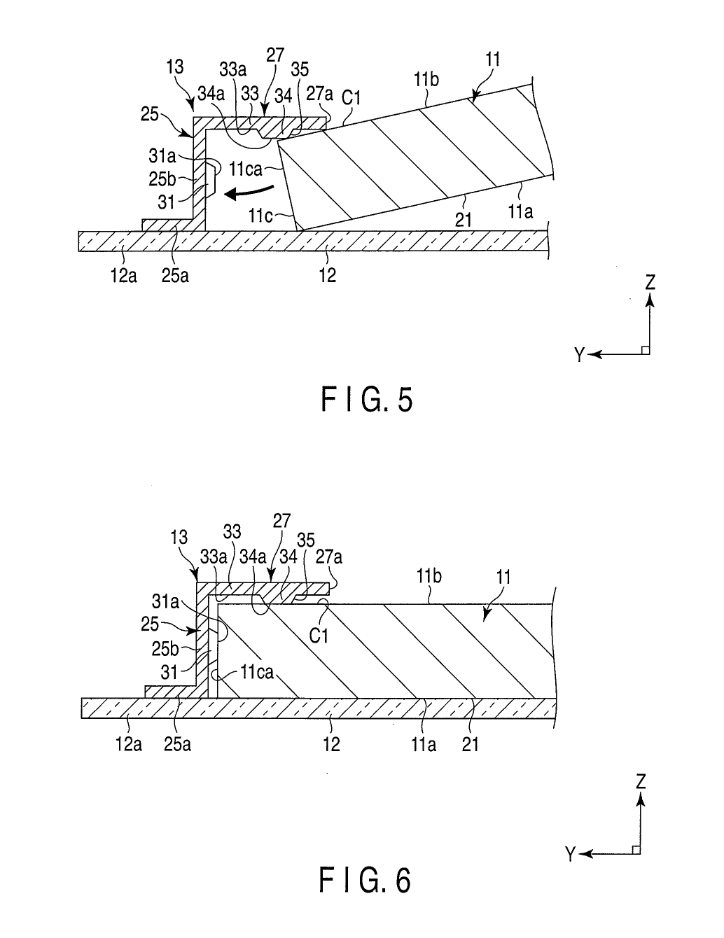

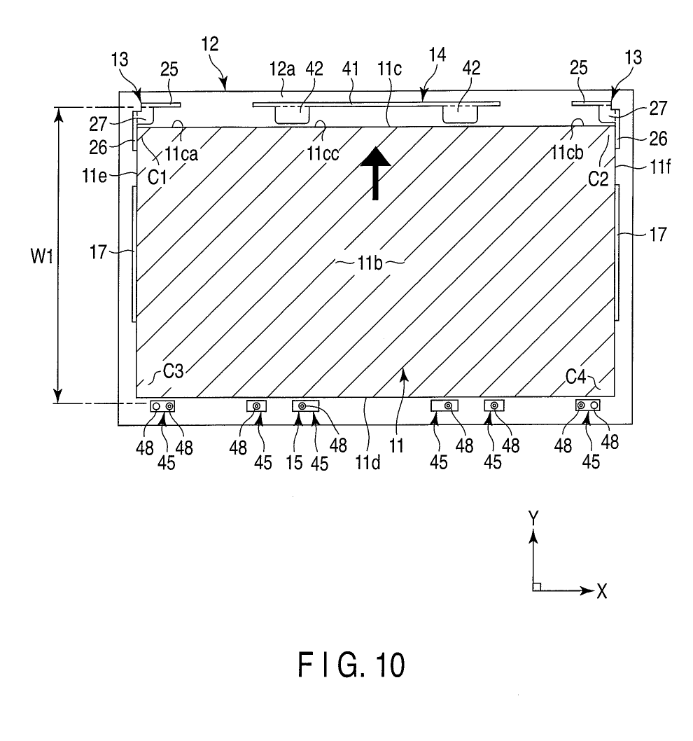

An example of the display panel 11 is a liquid crystal display. The display panel 11 may be other display devices, such as a plasma display and an organic EL display. The display panel 11 is a flat panel having a substantially rectangular shape. As shown in FIGS. 5 and 10, the display panel 11 includes a front surface 11a, a rear surface 11b, an upper surface 11c, a lower surface 11d, a first side surface 11e, and a second side surface 11f.

The front surface 11a is an example of a “first surface.” The front surface 11a includes a display screen 21. The front surface 11a faces the glass panel 12. The rear surface 11b is an example of a “second surface.” The rear surface 11b is opposite to the front surface 11a and faces the back cover 19.

The upper surface 11c is an example of a “third surface.” The first side surface 11e is an example of a “fourth surface.” The second side surface 11f is an example of a “fifth surface.” The lower surface 11d is an example of a “sixth surface.” The upper surface 11c, the first side surface 11e, the second side surface 11f, and the lower surface 11d extend substantially orthogonal to the front surface 11a and the rear surface 11b between the front surface 11a and the rear surface 11b.

As shown in FIG. 10, the upper surface 11c extends in the longitudinal direction of the display panel 11. The lower surface 11d is opposite to the upper surface 11c and extends in the longitudinal direction of the display panel 11. The first side surface 11e is substantially orthogonal to the upper surface 11c and extends in the lateral direction of the display panel 11. The second side surface 11f is opposite to the first side surface 11e. The second side surface 11f is substantially orthogonal to the upper surface 11c and extends in the lateral direction of the display panel 11.

The upper surface 11c includes a first end portion 11ca, a second end portion 11cb, and a central portion 11cc. The first end portion 11ca is connected to the first side surface 11e. The second end portion 11cb is connected to the second side surface 11f. The central portion 11cc is between the first end portion 11ca and the second end portion 11cb.

A first corner C1 is formed between the upper surface 11c and the first side surface 11e. A second corner C2 is formed between the upper surface 11c and the second side surface 11f. A third corner C3 is formed between the lower surface 11d and the first side surface 11e. A fourth corner C4 is formed between the lower surface 11d and the second side surface 11f. The first corner C1 and the second corner C2 are at the upper end portions of the display panel 11. The third corner C3 and the fourth corner C4 are at the lower end portions of the display panel 11.

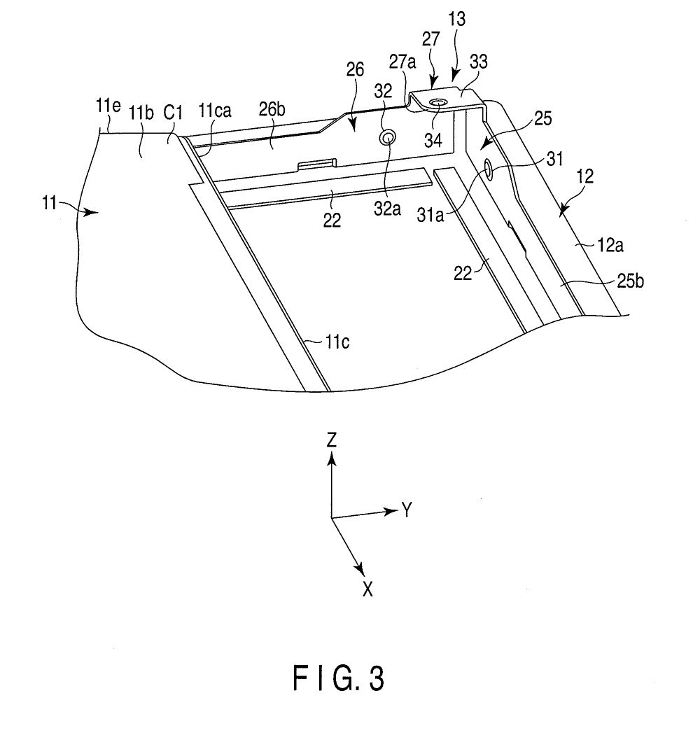

The glass panel 12 is an example of a front panel and is also an example of a front cover. For example, the display panel 11 overlaps the glass panel 12 with a buffer member 22 (FIG. 3) interposed therebetween. For convenience of explanation, the buffer member 22 is not shown in the other drawings.

As shown in FIGS. 1 and 6, the glass panel 12 covers the front surface 11a of the display panel 11. The front cover attached to the display panel 11 may be a frame member having an opening portion in the front surface thereof. The front panel attached to the display panel 11 may be a plastic member such as an acrylic member.

As shown in FIG. 10, the glass panel 12 has a substantially rectangular shape with a size larger than that of the display panel 11. The glass panel 12 includes a portion that overlaps the display panel 11 and a marginal portion 12a that protrudes from the display panel 11. The first fixing portions 13, the second fixing portion 14, the third fixing portion 15, and the fifth fixing portions 17 are attached to the marginal portion 12a.

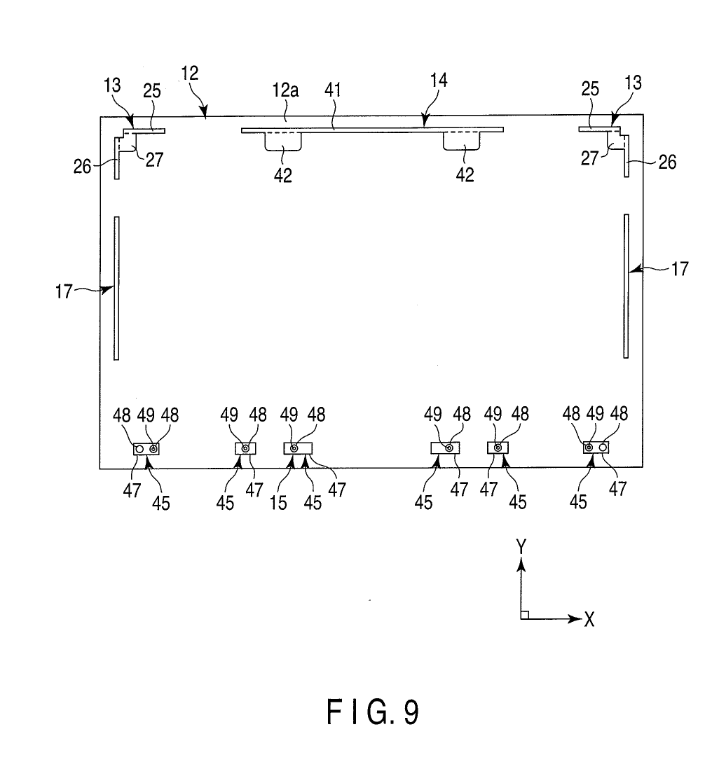

As shown in FIG. 9, for example, a pair of first fixing portions 13 is symmetrically provided. One of the first fixing portions 13 is at the upper right portion of the glass panel 12 and supports the first corner C1 of the display panel 11. The other first fixing portion 13 is at the upper left portion of the glass panel 12 and supports the second corner C2 of the display panel 11.

FIGS. 3 to 6 show the first fixing portion 13 supporting the first corner C1 of the display panel 11 in detail. The first fixing portion 13 supporting the second corner C2 has substantially the same structure as the first fixing portion 13 supporting the first corner C1. Components having the same functions are denoted by the same reference numerals and a description thereof will not be repeated.

As shown in FIG. 3, the first fixing portion 13 is, for example, a metal plate. The first fixing portion 13 includes a first supporting portion 25, a second supporting portion 26, and a third supporting portion 27. The first supporting portion 25 is an example of a “first portion.” The third supporting portion 27 is an example of a “second portion.” The second supporting portion 26 is an example of a “third portion.”

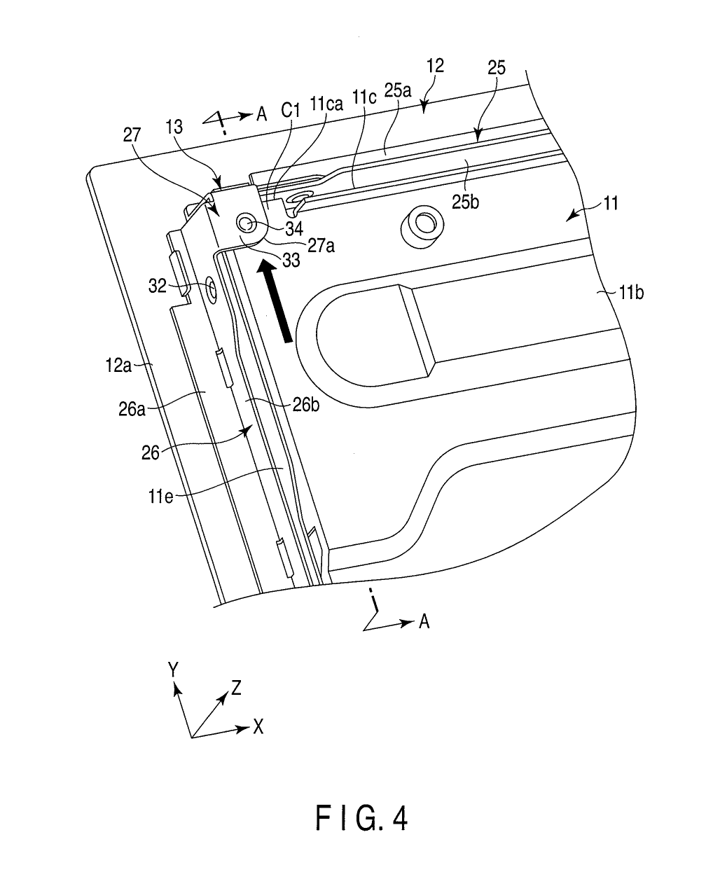

As shown in FIGS. 4 and 5, the first supporting portion 25 includes an attachment portion 25a and a rising portion 25b (e.g., standing portion). The attachment portion 25a is fixed to the glass panel 12 by, for example, an adhesive. The rising portion 25b is bent from the attachment portion 25a and rises substantially orthogonal to the glass panel 12. That is, the first supporting portion 25 has an L shape in a cross-sectional view.

Next, a first direction X, a second direction Y, and a third direction Z are defined. The first direction X is the longitudinal direction of the display panel 11. The second direction Y is the lateral direction of the display panel 11 and is substantially orthogonal to the first direction X. The third direction Z is the thickness direction of the display panel 11 and is substantially orthogonal to the first direction X and the second direction Y.

The first supporting portion 25 extends in the first direction X along the upper surface 11c of the display panel 11. The first supporting portion 25 faces the upper surface 11c of the display panel 11. As shown in FIG. 3, the first supporting portion 25 includes a first projection 31 that protrudes toward the upper surface 11c of the display panel 11 and comes into contact with the upper surface 11c of the display panel 11. The end portion of the first projection 31 includes a flat portion 31a in a plane shape.

As shown in FIGS. 2 and 4, similar to the first supporting portion 25, the second supporting portion 26 includes an attachment portion 26a and a rising portion 26b (e.g., standing portion). The attachment portion 26a is fixed to the glass panel 12 by, for example, an adhesive. The rising portion 26b is bent from the attachment portion 26a and rises substantially orthogonal to the glass panel 12. That is, the second supporting portion 26 has an L shape in a cross-sectional view.

The second supporting portion 26 extends in a direction substantially orthogonal to the first supporting portion 25. The second supporting portion 26 extends in the second direction Y along the first side surface 11e of the display panel 11. The second supporting portion 26 faces the first side surface 11e of the display panel 11. As shown in FIG. 3, the second supporting portion 26 includes a second projection 32 that protrudes toward the first side surface 11e of the display panel 11 and comes into contact with the first side surface 11e of the display panel 11. The end portion of the second projection 32 includes a flat portion 32a in a plane shape.

As shown in FIGS. 3 and 4, the third supporting portion 27 extends between the end portion of the first supporting portion 25 and the end portion of the second supporting portion 26. The third supporting portion 27 is bent with respect to the first supporting portion 25 and the second supporting portion 26 and is substantially orthogonal to the first supporting portion 25 and the second supporting portion 26. The third supporting portion is substantially parallel to the glass panel 12 and faces the glass panel 12. That is, the third supporting portion 27 faces the rear surface 11b of the display panel 11.

As shown in FIGS. 3 and 5, the third supporting portion 27 includes a flat portion 33 and a third projection 34. The flat portion 33 is formed in a plate shape and is substantially parallel to the display panel 11. The third projection 34 is on an inner surface 33a of the flat portion 33. The third projection 34 protrudes toward the rear surface 11b of the display panel 11 and comes into contact with the rear surface 11b of the display panel 11.

As shown in FIG. 5, the third projection 34 is at a position inward from an edge 27a of the third supporting portion 27. A step portion 35 is formed between the third projection 34 and the edge 27a of the third supporting portion 27 due to the difference in height between the third projection 34 and the flat portion 33. The leading end portion of the third projection 34 includes a flat portion 34a in a plane shape.

As shown in FIGS. 3 to 6, 10, and 11, the display panel 11 is slid to a position where a portion of the display panel 11 is interposed between the third supporting portions 27 of the first fixing portions 13 and the glass panel 12 and overlaps the glass panel 12. Specifically, the display panel 11 is slid toward the first supporting portions 25 of the first fixing portions 13 such that the first side surface 11e and the second side surface 11f are along the second supporting portions 26 of the first fixing portions 13. In this way, the first corner C1 and the second corner C2 of the display panel 11 are inserted between the glass panel 12 and the third supporting portions 27 of the first fixing portions 13.

The upper surface 11c of the display panel 11 comes into contact with the first supporting portions 25 of the first fixing portions 13. In this way, the position of the display panel 11 in the second direction Y is regulated. The first side surface 11e of the display panel 11 comes into contact with the second supporting portion 26 of one of the pair of first fixing portions 13. The second side surface 11f of the display panel 11 comes into contact with the second supporting portion 26 of the other first fixing portion 13. That is, the display panel 11 is interposed between the second supporting portions 26 of the pair of first fixing portions 13 in the left-right direction. In this way, the position of the display panel 11 in the first direction X is regulated and the display panel 11 is not moved in the first direction X.

The rear surface 11b of the display panel 11 comes into contact with the third supporting portions 27 of the first fixing portions 13. In this way, the position of the display panel 11 in the third direction Z is regulated. That is, the position of the display panel 11 in three directions, that is, the first to third directions X, Y, and Z is regulated by one fixing portion 13.

As shown in FIG. 9, the second fixing portion 14 is at the upper center portion of the glass panel 12 and supports the center portion of the upper edge portion of the display panel 11. As shown in FIG. 2, the second fixing portion 14 is, for example, a metal plate. The second fixing portion 14 includes a first supporting portion 41 and, for example, two second supporting portions 42. The number of second supporting portions 42 may be one or three or more.

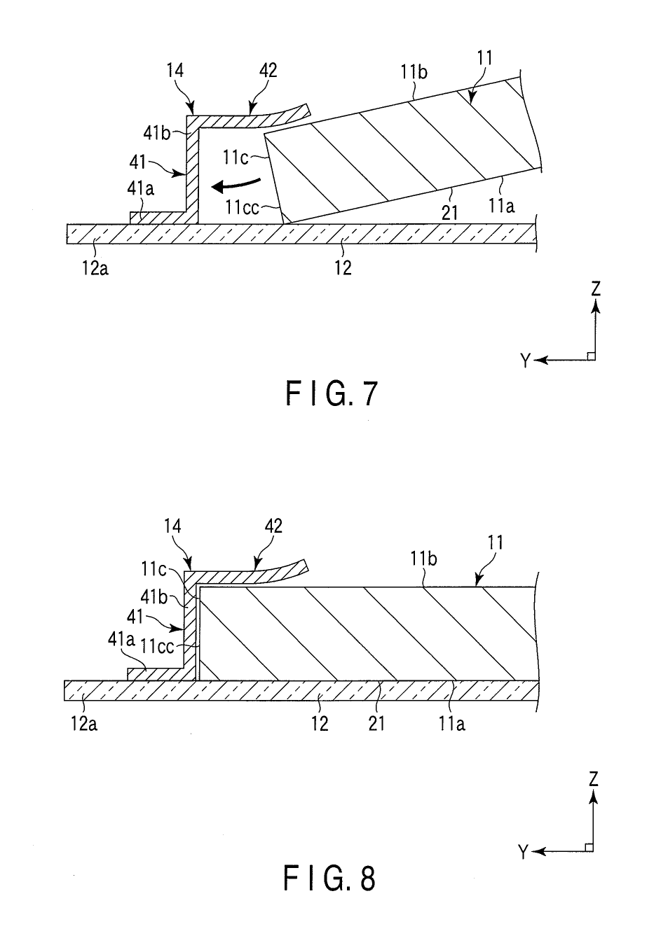

As shown in FIG. 7, the first supporting portion 41 includes an attachment portion 41a and a rising portion 41b (e.g., standing portion). The attachment portion 41a is fixed to the glass panel 12 by, for example, an adhesive. The rising portion 41b is bent from the attachment portion 41a and rises substantially orthogonal to the glass panel 12. That is, the first supporting portion 41 has an L shape in a cross-sectional view. As shown in FIG. 10, the first supporting portion 41 extends in the first direction X along the upper surface 11c of the display panel 11. The first supporting portion 41 faces the central portion 11cc of the upper surface 11c of the display panel 11.

As shown in FIG. 7, the second supporting portion 42 is bent from the end portion of the first supporting portion 41 and is substantially orthogonal to the first supporting portion 41. The second supporting portion 42 is substantially parallel to the glass panel 12 and faces the glass panel 12. That is, the second supporting portion 42 faces the rear surface 11b of the display panel 11. The end portion of the second supporting portion 42 is bent in a direction away from the display panel 11.

As shown in FIGS. 7, 8, 10, and 11, the display panel 11 is inserted into the first fixing portions 13 and the second fixing portion 14 at the same time. That is, the display panel 11 is slid to a position where a portion of the display panel 11 is interposed between the glass panel 12 and the second supporting portions 42 of the second fixing portion 14. Specifically, the display panel 11 is slid toward the first supporting portion 41 of the second fixing portion 14. In this way, the center portion of the upper edge portion of the display panel 11 is inserted between the glass panel 12 and the second supporting portions 42 of the second fixing portion 14.

The upper surface 11c of the display panel 11 faces the first supporting portion 41 of the second fixing portion 14. The rear surface 11b of the display panel 11 faces the second supporting portions 42 of the second fixing portion 14. In this way, the position of the display panel 11 in the second direction Y and the third direction Z is reliably regulated. For example, a small gap (clearance) is left between the first supporting portion 41 of the second fixing portion 14 and the display panel 11 and between the second supporting portions 42 and the display panel 11. The position of the display panel 11 is determined by the three projections 31, 32, and 34 of the first fixing portion 13.

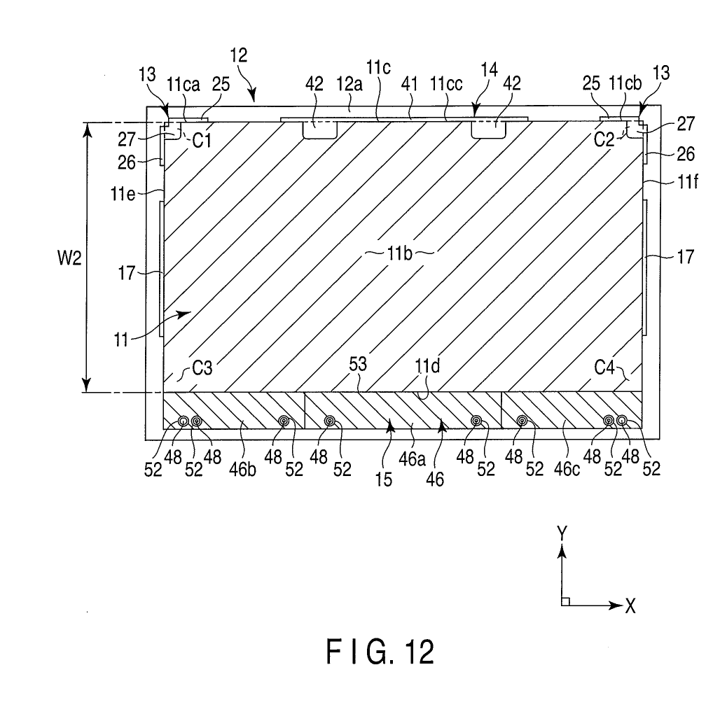

As shown in FIG. 12, the third fixing portion 15 is at the lower end portion of the glass panel 12 and supports the lower edge portion of the display panel 11. The third fixing portion 15 is an example of “another fixing portion.” The third fixing portion 15 is attached to the glass panel 12 and faces the display panel 11 on the opposite side of the first supporting portions 25 of the first fixing portions 13 and the first supporting portion 41 of the second fixing portion 14.

As shown in FIG. 2, the third fixing portion 15 includes, for example, a plurality of first members 45 fixed to the glass panel 12 and a second member 46 detachably attached to the first members 45. Only one first member 45 may be provided. The first member 45 includes an attachment portion 47 and a boss 48. The attachment portion 47 is formed in a plate shape and is fixed to the glass panel 12 by, for example, an adhesive.

The boss 48 is vertically provided on the attachment portion 47 and extends in a direction substantially orthogonal to the glass panel 12. As shown in FIG. 10, a gap W1 between the boss 48 and the first supporting portion 25 of the first fixing portion 13 is more than the width of the display panel 11 in the lateral direction. Some bosses 48 include screw holes 49. As shown in FIG. 2, screws 50 for fixing the back cover 19 are inserted into the screw holes 49.

As shown in FIGS. 2 and 12, the second member 46 is a engaging member engaged to at least one of the bosses 48. The second member 46 includes, for example, three removable pieces 46a, 46b, and 46c. The second member 46 may be a member provided by integrally forming the three pieces 46a, 46b, and 46c. The second member 46 includes, for example, speaker holes 51 in the second direction Y. A speaker (not shown) is attached to the second member 46.

The second member 46 includes through holes 52 into which the bosses 48 are inserted. The second member 46 is attached to the bosses 48 in a direction substantially orthogonal to the glass panel 12. When the bosses 48 are inserted into the through holes 52, the movement of the second member 46 in the first direction X and the second direction Y is regulated.

As shown in FIG. 12, the second member 46 includes a supporting surface 53 facing the lower surface 11d of the display panel 11. A gap W2 between the supporting surface 53 and the first supporting portion 25 of the first fixing portion 13 is substantially equal to the width of the display panel 11 in the lateral direction. The display panel 11 is interposed between the second member 46, and the first supporting portions 25 of the first fixing portion 13 and the first supporting portion 41 of the second fixing portion 14.

The second member 46 regulates the position of the display panel 11 in the second direction Y in cooperation with the first supporting portions 25 of the first fixing portions 13 and the first supporting portion 41 of the second fixing portion 14. In this way, the display panel 11 is not moved in the second direction Y.

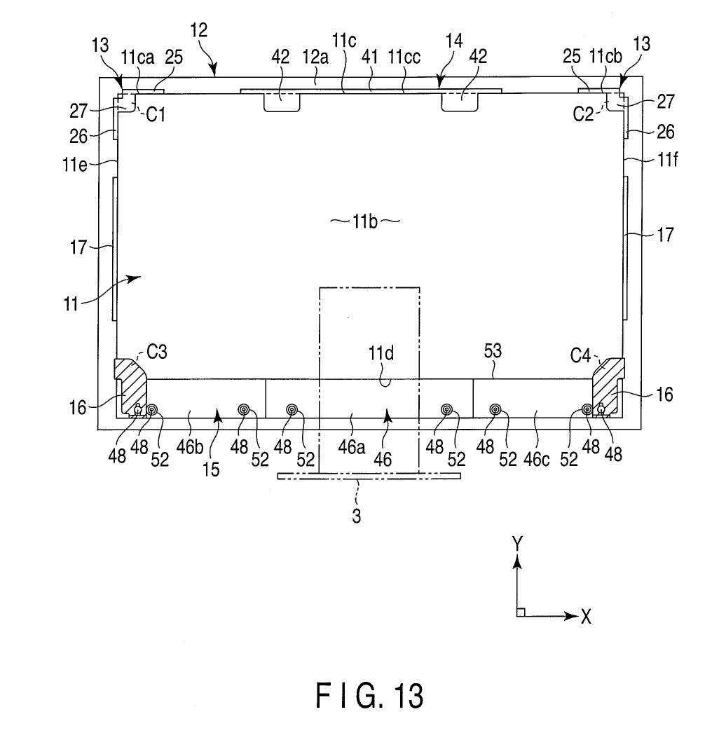

As shown in FIGS. 2 and 13, the fourth fixing portions 16 are attached to the bosses 48 at the left and right ends. For example, slits (not shown) are in the outer circumferential surfaces of the bosses 48. The fourth fixing portion 16 is, for example, a metal plate. The fourth fixing portion 16 is fitted to the slit such that the position thereof is fixed.

The fourth fixing portion 16 is detachably attached to the third fixing portion 15 and faces the rear surface 11b of the display panel 11. Specifically, for example, a pair of fourth fixing portions 16 is provided. One of the pair of fourth fixing portions 16 faces the rear surface 11b of the third corner C3 of the display panel 11. The other fourth fixing portion 16 faces the rear surface 11b of the fourth corner C4 of the display panel 11.

The fourth fixing portions 16 regulate the position of the display panel 11 in the third direction Z in cooperation with the third supporting portions 27 of the first fixing portions 13 and the second supporting portion 42 of the second fixing portion 14. In this way, the display panel 11 is not moved in the third direction Z.

A pair of fifth fixing portions 17 is at the right and left end portions of the glass panel 12. The fifth fixing portion 17 extends in the second direction Y along the first side surface 11e or the second side surface 11f of the display panel 11. The pair of fifth fixing portions 17 regulates the position of the display panel 11 in the first direction X in cooperation with the second supporting portions 26 of the first fixing portions 13.

The bezel 18 has a frame shape with a size larger than that of the display panel 11 and is attached to the first fixing portions 13, the second fixing portion 14, and the fifth fixing portions 17. In this way, the upper surface 11c, the first side surface 11e, the second side surface 11f, and the lower surface 11d of the display panel 11 are covered and concealed.

The back cover 19 is attached to, for example, the third fixing portion 15 and the fifth fixing portions 17. The back cover 19 covers the rear surface 11b of the display panel 11. As shown in FIG. 13, the stand 3 is directly connected to the display panel 11 and supports the display panel 11. That is, the weight of the display panel 11 is directly applied to the stand 3 without passing through the first to fifth fixing portions 13, 14, 15, 16, and 17.

Next, an assembly method of the television 1 will be described. In FIGS. 10 to 13, for convenience of explanation, some components are hatched.

As shown in FIG. 9, the first fixing portions 13, the second fixing portion 14, the first members 45 of the third fixing portion 15, and the fifth fixing portions 17 are fixed to the glass panel 12. In this state, the display panel 11 is attached to the glass panel 12. Specifically, as shown in FIG. 10, the upper surface 11c of the display panel 11 is slid toward the first supporting portions 25 of the first fixing portions 13 and the first supporting portion 41 of the second fixing portion 14, with the first side surface 11e and the second side surface 11f of the display panel 11 moved along the second supporting portions 26 of the pair of first fixing portions 13.

In this case, as shown in FIGS. 5 and 7, the display panel 11 is slid toward the first supporting portions 25 of the first fixing portions 13 and the first supporting portion 41 of the second fixing portion 14, with the lower surface 11d lifted up with respect to the upper surface 11c. Since the third supporting portion 27 of the first fixing portion 13 includes the step portion 35 and the end portion of the second supporting portion 42 of the second fixing portion 14 is bent, the display panel 11 does not interfere with the first fixing portions 13 and the second fixing portion 14 even when the display panel 11 obliquely slides.

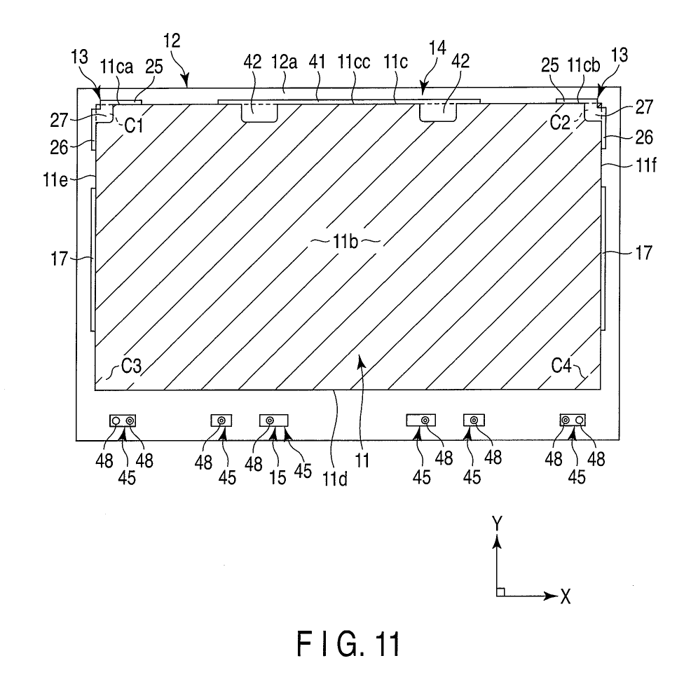

As shown in FIGS. 6 and 11, when the display panel 11 is slid to the deepest position, the first supporting portions 25, the second supporting portions 26, and the third supporting portions 27 of the first fixing portion 13 come into contact with the upper surface 11c, the first side surface 11e, the second side surface 11f, and the rear surface 11b of the display panel 11, respectively. In this way, the position of the display panel 11 is determined.

Next, as shown in FIG. 12, the second member 46 is attached to the first members 45 of the third fixing portion 15. In this way, the supporting surface 53 of the second member 46 faces the lower surface 11d of the display panel 11. That is, the display panel 11 is interposed between the first and second fixing portions 13 and 14 and the second member 46 of the third fixing portion 15. In this way, the display panel 11 does not fall down.

Then, as shown in FIG. 13, the fourth fixing portions 16 are attached to the third fixing portion 15. The fourth fixing portion 16 faces the rear surface 11b of the lower end portion of the display panel 11. In this way, the display panel 11 is not taken off in the third direction Z. In this way, the movement of the display panel 11 is completely regulated. Then, the bezel 18 is attached, a circuit board (not shown) and a speaker (not shown) are mounted, and the back cover 19 and the stand 3 are attached. In this way, the television 1 is assembled.

According to the above-mentioned structure, it is possible to reduce the number of components in an electronic apparatus. That is, the television 1 according to this embodiment includes the first fixing portion 13 including the first supporting portion 25 rising with respect to the glass panel 12 and the third supporting portion 27 facing the glass panel 12, and the display panel 11 which is slid to the position where a portion of the display panel 11 is interposed between the glass panel 12 and the third supporting portions 27 and overlaps the glass panel 12. That is, the movement of the display panel 11 in the third direction Z is regulated by a portion of the first fixing portion 13 that regulates the movement of the display panel 11 in the second direction Y. Therefore, it is possible to reduce the number of attachment members or screws for regulating the movement of the display panel 11 in the third direction Z. In this way, it is possible to reduce the number of components.

In addition, since the display panel 11 can be attached by sliding insertion, it is possible to improve attachment workability and reduce the operating time, as compared to the structure in which the display panel is screwed.

In this embodiment, the first fixing portion 13 includes the second supporting portion 26 facing the display panel 11 in the first direction X. That is, in this embodiment, the movement of the display panel 11 in the third direction Z is regulated by a portion of the first fixing portion 13 that regulates the movement of the display panel 11 in the first direction X and the second direction Y. In this way, it is possible to reduce the number of components.

In this embodiment, the second fixing portion 14 that supports the central portion 11cc of the upper surface 11c of the display panel 11 is provided. In this way, the position of the display panel 11 in the second direction Y is reliably regulated.

In this embodiment, the third supporting portion 27 of the first fixing portion 13 includes the flat portion 33 substantially parallel to the display panel 11 and the projection 34 provided on the flat portion 33 so as to protrude toward the display panel 11. According to this structure, since the position of the display panel 11 is determined by the projection 34, it is possible to accurately determine the position of the display panel 11.

In this embodiment, the step portion 35 is formed between the projection 34 and the edge 27a of the third supporting portion 27 due to the difference in height between the projection 34 and the flat portion 33. According to this structure, as shown in FIG. 5, it is possible to obliquely insert the display panel 11. Since the display panel 11 can be obliquely inserted, workability is improved. In addition, since the front surface 11a of the display panel 11 is less likely to come into contact with the glass panel 12, the front surface 11a of the display panel 11 is less likely to be damaged.

In this embodiment, the end portion of the second supporting portion 42 of the second fixing portion 14 is bent in a direction away from the display panel 11. According to this structure, as shown in FIG. 7, it is possible to obliquely insert the display panel 11 even in the structure including the second fixing portion 14.

In this embodiment, the third fixing portion 15 includes the first members 45 fixed to the glass panel 12, and the second member 46 detachably attached to the first members 45 and facing the first supporting portions 25 of the first fixing portions 13 and the first supporting portion 41 of the second fixing portion 14 with the display panel 11 interposed therebetween. According to this structure, the movement of the display panel 11 in the vertical direction can be regulated by the first fixing portions 13, the second fixing portion 14, and the third fixing portion 15. Therefore, it is possible to reliably fix the position of the display panel 11.

In this embodiment, each of the first members 45 of the third fixing portion 15 includes the boss 48 rising with respect to the glass panel 12, and the second member 46 includes the through holes 52 into which the bosses 48 are inserted and is attached to the bosses 48 in a direction substantially orthogonal to the glass panel 12. According to this structure, it is possible to form a component that faces the first fixing portions 13 and the second fixing portion 14 with the display panel 11 interposed therebetween with a simple structure.

In this embodiment, the television 1 includes the fourth fixing portions 16 detachably attached to the third fixing portion 15 and facing the rear surface 11b of the display panel 11. According to this structure, it is possible to press the upper and lower end portions of the rear surface 11b of the display panel 11 with the fourth fixing portions 16 and the third supporting portions 27 of the first fixing portions 13. In this way, it is possible to reliably fix the position of the display panel 11.

In this embodiment, a pair of first fixing portions 13 is provided so as to correspond to the left and right end portions of the display panel 11, and the display panel 11 is interposed between the second supporting portions 26 of the pair of first fixing portions 13. According to this structure, it is possible to reliably fix the position of the display panel 11 in the first direction X using the pair of first fixing portions 13.

The embodiment is not limited to the above-described embodiment, but the components of the above-described embodiment may be changed without departing from the scope and spirit of the invention. In addition, a plurality of components according to the above-described embodiment may be appropriately combined with each other to form various structures. For example, some of the components according to the above-described embodiment may be removed. Components according to different embodiments may be appropriately combined with each other.

For example, the first to fifth fixing portions 13, 14, 15, 16, and 17 are not limited to the metal plate, but may be made of other materials. The second to fifth fixing portions 14, 15, 16, and 17 are not indispensable components, but may be appropriately omitted.

The first fixing portion 13 does not necessarily include the projections 31, 32, and 34. The third supporting portion 27 may include only the flat portion 33. The display panel 11 may be slid along the glass panel 12 and be inserted. The second supporting portion 42 of the second fixing portion 14 is not necessarily bent. The structure, position, and shape of each of the first to fifth fixing portions 13, 14, 15, 16, and 17 may be appropriately changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a transparent front panel;
a display panel comprising
a first surface comprising a display screen and facing the transparent front panel,
a second surface opposite the first surface,
a third surface extending between the first surface and the second surface,
and a fourth surface extending between the first surface and the second surface and substantially orthogonal to the third surface; a first fixing portion comprising
a first supporting portion attached to the transparent front panel and facing the third surface of the display panel,
a second supporting portion attached to the transparent front panel and facing the fourth surface of the display panel, and
a third supporting portion extending between the first supporting portion and the second supporting portion and facing the second surface of the display panel, wherein the display panel is configured to be slid toward the first supporting portion along the second supporting portion such that a corner portion of the display panel is inserted between the transparent front panel and the third supporting portion;
a second fixing portion comprising
a first supporting portion attached to the transparent front panel and facing a central portion of the third surface of the display panel, and
a second supporting portion bent or otherwise formed from the first supporting portion of the second fixing portion and facing the second surface of the display panel; and
a third fixing portion attached to the transparent front panel and facing the display panel on the opposite side of the first supporting portion of the first fixing portion and the first supporting portion of the second fixing portion.

2. The television of claim 1,
wherein the third supporting portion of the first fixing portion comprises a flat portion substantially parallel to the display panel, and a projection on the flat portion, protruding toward the display panel.

3. The television of claim 2,
wherein the projection is spaced from an edge of the third supporting portion, and
the third supporting portion comprises a step portion between the projection and the edge of the third supporting portion due to a difference in height between the projection and the flat portion.

4. The television of claim 1,
wherein an end portion of the second supporting portion of the second fixing portion is bent or otherwise formed in a direction away from the display panel.

5. The television of claim 1,
wherein the third fixing portion comprises a first member attached to the transparent front panel, and a second member detachably attached to the first member and facing the first supporting portion of the first fixing portion and the first supporting portion of the second fixing portion with the display panel interposed therebetween.

6. The television of claim 5,
wherein the first member comprises a boss on the transparent front panel, and
the second member comprises a hole into which the boss can be inserted and attached to the boss in a direction substantially orthogonal to the transparent front panel.

7. The television of claim 1, further comprising:
a fourth fixing portion detachably attached to the third fixing portion and facing the second surface of the display panel.

8. The television of claim 1,
wherein a pair of the first fixing portions is provided so as to correspond to both end portions of the display panel, and
the display panel is interposed between the second supporting portions of the pair of first fixing portions.

9. An electronic apparatus comprising:
a transparent front panel;
a first fixing portion comprising
a first portion attached to the transparent front panel, and
a second portion configured to face the transparent front panel; and
a display panel configured to be slid up to a position where a portion of the display panel is interposed between the transparent front panel and the second portion of the first fixing portion and to overlap the transparent front panel.

10. The electronic apparatus of claim 9, further comprising:
a second fixing portion configured to be attached to the transparent front panel and to face the first portion of the first fixing portion with the display panel interposed between the second fixing portion and the first portion of the first fixing portion.
